(19) United States
(12) Patent Application Publication
(10) Pub. No.: US 2024/0114543 A1
(43) Pub. Date: Apr. 4, 2024

(54) METHODS FOR SIDELINK COMMUNICATION, TERMINAL DEVICE, AND COMPUTER READABLE MEDIA

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 18/272,247

(22) PCT Filed: Jan. 13, 2021
(86) PCT No.: PCT/CN2021/071448

§ 371 Date: Jul. 13, 2023

(51) Int. Cl. H04W 72/542; H04B 17/318; H04W 72/02; H04W 72/0446

(52) U.S. Cl. CPC H04W 72/542; H04B 17/328; H04W 72/02; H04W 72/0446

(57) ABSTRACT

Embodiments of the present disclosure provide a solution for sidelink communications. In a method for communications, a first terminal device determines from a resource pool configured for the first terminal device, first resources in a time window before a first slot based on a resource selection scheme of the first terminal device. The first terminal device determines a first number of occupied resources in the first resources. The first terminal device determines a congestion level indicator of a sidelink channel for the first slot based at least in part on the first number and a number of the first resources. The sidelink channel is associated with the first terminal device. With the proposed mechanism, the sidelink congestion level indicator, such as, a channel busy ratio (CBR) is determined with consideration of the resource selection scheme and the reception capability of the terminal device. As such, the accuracy of CBR measurement can be improved, which is beneficial to sidelink congestion control and a reduction of the power consumption at the terminal device.

### FIELD

Embodiments of the present disclosure generally relate to the field of communication, and more particularly, to a solution of sidelink communications.

### BACKGROUND

As one of the key technologies for the fifth-generation communication system, which is also referred to new radio (NR) technology, vehicle to everything (V2X) technologies can be based on D2D communication technologies, for example, the sidelink communication technology. There are two modes of resource allocation for V2X communications in the 5G system. For a first mode (also referred to as NR V2X mode 1 or mode 1 hereinafter), one terminal device may communicate with the other terminal device by using resources allocated by a network device. For a second mode (also referred to as NR V2X mode 2 or mode 2 hereinafter), one terminal device may perform V2X communications with the other terminal device on resources in a preconfigured resource pool.

The resources in mode 2 may be determined in an autonomously selection manner, for example, by using one of a full sensing scheme, a partial sensing scheme or a random selection scheme. Additionally or alternatively, the terminal devices in V2X communications may have different reception capabilities, for example, some of the terminal devices may not be capable of performing reception of any SL signals and channels and some of the terminal devices is capable of performing reception of only PSCCH and some of the terminal devices is capable of performing all or part of SL signals and channels defined in NR V2X. What's more, some of the terminal devices may operate in a discontinuous reception (DRX) mode. Although congestion control is beneficial for the terminal devices in terms of power saving, conventional solutions for congestion control are not feasible for some scenarios, especially for mode 2.

### SUMMARY

In general, example embodiments of the present disclosure provide a solution for sidelink congestion control.

In a first aspect, there is provided a method for communications. The method comprises: determining, at a first terminal device from a resource pool configured for the first terminal device, first resources in a time window before a first slot based on a resource selection scheme of the first terminal device; determining a first number of occupied resources in the first resources; and determining a congestion level indicator of a sidelink channel of the first terminal device in the first slot based at least in part on the first number and a number of the first resources.

In a second aspect, there is provided a method for communications. The method comprises: in accordance with a determination that a preconfigured time window overlaps with an off duration of a discontinuous receipt cycle of a second terminal device, determining a target time window at the second terminal device, both the target time window and the preconfigured time window associated with a congestion level indicator of a sidelink channel of the second terminal device in a first slot; determining a first number of occupied resources from target resources in a resource pool configured for the second terminal device in the target time window; and determining the indicator based at least in part on the first number and a number of the target resources.

In a third aspect, there is provided a method performed by a terminal device. The method comprises: obtaining signal strength parameters by measuring signals on target resources of a sidelink channel in a time window at a first slot, the sidelink channel associated with the terminal device; and determining a channel busy ratio for the first slot based at least in part on the signal strength parameters and a resource selection scheme of the terminal device.

In a fourth aspect, there is provided a first terminal device. The first terminal device comprises a processor and a memory storing instructions. The memory and the instructions are configured, with the processor, to cause the first terminal device to perform the method according to the first aspect.

In a fifth aspect, there is provided a second terminal device. The second terminal device comprises a processor and a memory storing instructions. The memory and the instructions are configured, with the processor, to cause the second terminal device to perform the method according to the second aspect.

In a sixth aspect, there is provided a terminal device. The terminal device comprises a processor and a memory storing instructions. The memory and the instructions are configured, with the processor, to cause the terminal device to perform the method according to the third aspect.

In a seventh aspect, there is provided a computer readable medium having instructions stored thereon. The instructions, when executed on at least one processor of a device, cause the device to perform the method according to the first aspect.

In an eighth aspect, there is provided a computer readable medium having instructions stored thereon. The instructions, when executed on at least one processor of a device, cause the device to perform the method according to the second aspect.

In a ninth aspect, there is provided a computer readable medium having instructions stored thereon. The instructions, when executed on at least one processor of a device, cause the device to perform the method according to the third aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication environment in which embodiments of the present disclosure may be implemented;

FIG. 2 illustrates a flowchart of an example method in accordance with some embodiments of the present disclosure;

FIG. 3 illustrates a schematic diagram of an example time window for determining a congestion level indicator in accordance with some embodiments of the present disclosure;

FIG. 4 illustrates a schematic diagram of an example frame structure in accordance with some embodiments of the present disclosure;

FIG. 5 illustrates a flowchart of an example method in accordance with some embodiments of the present disclosure;

FIG. 6 illustrates a schematic diagram of an example scheme for determining CBR in accordance with some embodiments of the present disclosure;

FIG. 7 illustrates a schematic diagram of an example scheme for determining CR in accordance with some embodiments of the present disclosure;

FIG. 8 illustrates a flowchart of an example method in accordance with some embodiments of the present disclosure; and

FIG. 9 is a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principles of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “network device” or “base station” (BS) refers to a device which is capable of providing or hosting a cell or coverage where terminal devices can perform communications. Examples of a network device include, but not limited to, a Node B (NodeB or NB), an Evolved NodeB (eNodeB or eNB), a next generation NodeB (gNB), an infrastructure device for a V2X (vehicle-to-everything) communication, a Transmission/Reception Point (TRP), a Remote Radio Unit (RRU), a radio head (RH), a remote radio head (RRH), a low power node such as a femto node, a pico node, and the like.

As used herein, the term “terminal device” or “user equipment” (UE) refers to any device having wireless or wired communication capabilities. The communications may involve transmitting and/or receiving wireless signals using electromagnetic signals, radio waves, infrared signals, and/or other types of signals suitable for conveying information over air. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UEs as examples of terminal devices and the terms “terminal device” and “user equipment” (UE) may be used interchangeably in the context of the present disclosure.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the term “transmission reception point,” “transmission/reception point,” or “transmission and reception point” may generally indicate a station communicating with the user equipment. However, the transmission and reception point may be referred to as different terms such as a base station (BS), a cell, a Node-B, an evolved Node-B (eNB), a next generation NodeB (gNB), a Transmission Reception Point (TRP), a sector, a site, a base transceiver system (BTS), an access point (AP), a relay node (RN), a remote radio head (RRH), a radio unit (RU), an antenna, and the like.

That is, in the context of the present disclosure, the transmission and reception point, the base station (BS), or the cell may be construed as an inclusive concept indicating a portion of an area or a function covered by a base station controller (BSC) in code division multiple access (CDMA), a Node-B in WCDMA, an eNB or a sector (a site) in LTE, a gNB or a TRP in NR, and the like. Accordingly, a concept of the transmission and reception point, the base station (BS), and/or the cell may include a variety of coverage areas such as a mega-cell, a macro-cell, a micro-cell, a pico-cell, a femto-cell, and the like. Furthermore, such concept may include a communication range of the relay node (RN), the remote radio head (RRH), or the radio unit (RU).

In the context of the present disclosure, the user equipment and the transmission/reception point may be two transmission/reception subjects, having an inclusive meaning, which are used to embody the technology and the technical concept disclosed herein, and may not be limited to a specific term or word. Furthermore, the user equipment and the transmission/reception point may be uplink or downlink transmission/reception subjects, having an inclusive meaning, which are used to embody the technology and the technical concept disclosed in connection with the present disclosure, and may not be limited to a specific term or word. As used herein, an uplink (UL) transmission/reception is a scheme in which data is transmitted from user equipment to a base station. Alternatively, a downlink (DL) transmission/reception is a scheme in which data is transmitted from the base station to the user equipment.

As used herein, the term “resource,” “transmission resource,” “resource block,” “physical resource block,” “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, a resource in both frequency domain and time domain will be used as an example of a transmission resource for describing some embodiments of the present disclosure. It is noted that embodiments of the present disclosure are equally applicable to other resources in other domains.

As used herein, the singular forms “a,” “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.”

As used herein, the terms “first”, “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In both legacy V2X (e.g., LTE-V2X) and the V2X in NR systems, congestion level indicators, such as, a channel busy ratio (CBR), a channel occupancy ratio (CR) and so on, may be used for sidelink congestion control. As previously mentioned, congestion control is beneficial for power saving terminal devices to achieve good system performances.

The Received Signal Strength Indicator (RSSI) measured on a sidelink channel may be used as an indicator in determining whether a resource is “busy”. Specifically, RSSI is defined as a linear average of the total received power (in [W]) observed in the configured sub-channel in OFDM symbols of a slot configured for a physical sidelink shared channel (PSSCH) and a physical sidelink control channel (PSCCH), which starts from the 2nd OFDM symbol. The CBR for sidelink communication may be measured at slot n based on a CBR measurement window [n−a, n−1], where a may be equal to 100 or 100·2^{μ} slots, according to higher layer parameter sl-TimeWindowSizeCBR. The CBR may be defined as the portion of sub-channels in a resource pool on which the measured SL RSSI exceeds a (pre-)configured threshold. A range of CBR may be configured with a set of TX parameters including allowed MCS, max retransmission number, subchannel size, CR limit and etc.

A terminal device may be configured with a CR limit to limit the resources number for its transmissions. The CR at a certain slot n may be evaluated over a time window including a range of slots [n−a, n+b]. Specifically, the CR at a certain slot n may be determined as a ratio of a total number of sub-channels used for the terminal device's transmissions in slots [n−a, n−1] and sub-channels granted in slots [n, n+b] divided by a total number of configured sub-channels in the slots [n−a, n+b] where a is a positive integer and b is 0 or a positive integer; a and b are determined by UE implementation with a+b+1=1000 or 1000·2^{μ} slots, according to higher layer parameter sl-TimeWindowSizeCR, b<(a+b+1)/2, and n+b shall not exceed the last transmission opportunity of the grant for the current transmission.

Specifically, for sidelink congestion control in sidelink resource allocation mode 2, if a terminal device is configured with a higher parameter sl-CR-Limit and transmits PSSCH in slot n, the terminal device shall ensure:

Σ_{1≥k}CR(i)≤CR_{Limit}(k) (1)

where k represents a priority value of the terminal device, CR(i) represents the CR evaluated in slot n-N for the PSSCH transmissions with “priority” filed in the SCI set to i, and CR_{Limit}(k) corresponds to the higher layer parameter sl-CR-Limit that is associated with the priority vale k and the CBR range which includes the CBR measured in slot n−N, where N is the congestion control processing time that is based on the terminal device's processing capability as defined in TS 38.214.

The conventional definitions for the congestion level indicators as discussed above may not be suitable for the power saving UE in NR sidelink communications. For example, the power saving UE may utilize one of the partial sensing scheme and a random selection scheme or even falls into off-duration of a configured DRX period, and thus not monitoring or decoding every slot within the measurement window. As a result, the UEs may not monitor or decode every slot within the measurement window.

Additionally, the power saving UEs may vary in reception capabilities. For example, some of the UEs may receive signals on both the PSSCH and the PSCCH, some of the UEs may have no reception capability or not receive signals for some reason on the PSSCH, and some of the UEs may have no reception capability or not receive for some reason on both the PSSCH and PSCCH. Further, some of the UEs may operate in DRX mode. There is no mechanism of sidelink congestion control for the terminal devices in sidelink mode 2 communications taking the resource selection scheme, reception capabilities, the reception mode, DRX, etc., into consideration.

In order to solve the above and other potential problems, embodiments of the present disclosure provide a solution of sidelink congestion control, which can measure or evaluate the congestion level indicators by taking the resource selection scheme and specific reception behavior and DRX of the terminal devices into consideration. As such, the power consumption on determining the congestion level indicators can be reduced, while the accuracy of the congestion level indicators can be improved. This is also beneficial to the congestion control subsequently performed at the terminal device.

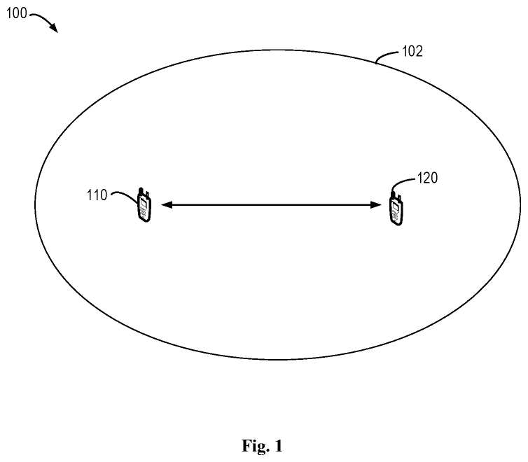

FIG. 1 illustrates an example communication environment 100 in which embodiments of the present disclosure may be implemented. As shown in FIG. 1, the communication environment 100, which may be a part of a communication network, includes a first terminal device 110 and a second terminal device 120. In the context of the present disclosure, the first terminal device 110 and the second terminal device 120 are using sidelink resource allocation mode 2. That is, in the example embodiments, the sidelink communication is performed on the resources in a resource pool 102, which is preconfigured for the first and second terminal devices 110 and 120.

Before performing transmissions on sidelink channels, the first and second terminal devices 110 and 120 may select resources by randomly selection in a predefined resource selection window in the resource pool 102 without sensing, or alternatively select resources after performing partial sensing in the resource pool 102.

Additionally, the first and second terminal devices 110 and 120 may vary from the reception capabilities. By way of example, one or both of the first and second terminal devices 110 and 120 may receive signals on both PSSCH and PSCCH. By way of another example, one or both of the terminal devices 110 and 120 may have no reception capability or for some reason may not receive signals on the PSSCH. Alternatively, one or both of the first and second terminal devices 110 and 120 may have no reception capability or for some reason not receive on both the PSSCH and PSCCH. The first and second terminal devices 110 and 120 may also be capable of operating in the DRX mode, which will be discussed in details later.

The first and second terminal devices 110 and 120 may perform congestion control for achieving better quality and performance of sidelink communications. In order to implement congestion control, the first and second terminal devices 110 and 120 may need to determine congestion level indicators, including but not limited to the CBR and CR.

The first and second terminal devices 110 and 120 may determine the CBR at a specific slot n by measuring signals received on resources of the resource pool 102. If the measured signal strength exceeds a predetermined threshold signal strength, a corresponding resource may be determined to be occupied or “busy”. Otherwise, if the measured signal strength does not exceed the predetermined threshold signal strength, the corresponding resource may be determined to be unoccupied or “not busy”. As such, the CBR at a specific slot n may be determined as a ratio of a number of occupied or “busy” resources to a total number resources of the resource pool 102 within a certain duration of the slots [n−a, n−1].

The CR at a specific slot n may be evaluated by determining a ratio of a sum of a number of resources used for transmissions of a respective one of the first and second terminal devices 110 and 120 in a past set of slots, e.g., [n−a, n−1], and a number of resources granted for a future set of slots, e.g., [n, n+b] to a total number of resources in the resource pool 102 within a duration of the slots[n−a, n+b].

It is to be understood that the number of the terminal devices 110 and 120 as shown in FIG. 1 is merely given for the purpose of illustration without suggesting any limitations. The communication environment 100 may include any suitable number of terminal devices, any suitable number of network devices, and any suitable number of other communication devices adapted for implementing embodiments of the present disclosure.

It would be appreciated that there may be various wireless communications as well as wireline communications (if needed) among all the communication devices. Moreover, it is noted that although the terminal devices 110 and 120 are schematically depicted as a mobile phone in FIG. 1, it is understood that these depictions are only for example without suggesting any limitation. In other embodiments, the terminal devices 110 and 120 may be any other devices with wireless communication capabilities, such as, vehicles.

The communications in the communication environment 100 may conform to any suitable standards including, but not limited to, Global System for Mobile Communications (GSM), Extended Coverage Global System for Mobile Internet of Things (EC-GSM-IoT), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), beyond 5G, the sixth generation (6G) communication protocols.

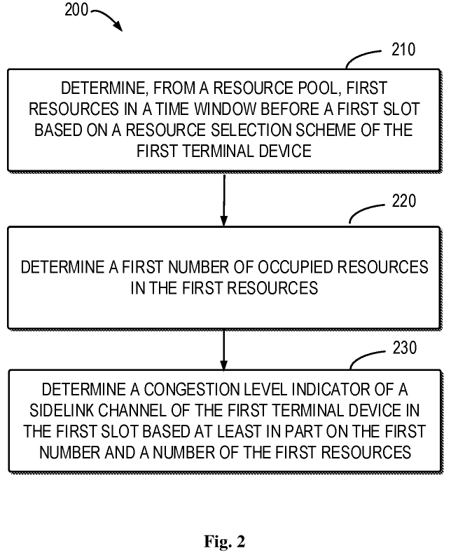

FIG. 2 illustrates a flowchart of an example method 200 in accordance with some embodiments of the present disclosure. In some embodiments, the method 200 can be implemented at a terminal device, such as the first terminal device 110 as shown in FIG. 1. Additionally, or alternatively, the method 200 can also be implemented at other terminal devices not shown in FIG. 1. For the purpose of discussion, the method 200 will be described with reference to FIG. 1 as performed by the first terminal device 110 without loss of generality.

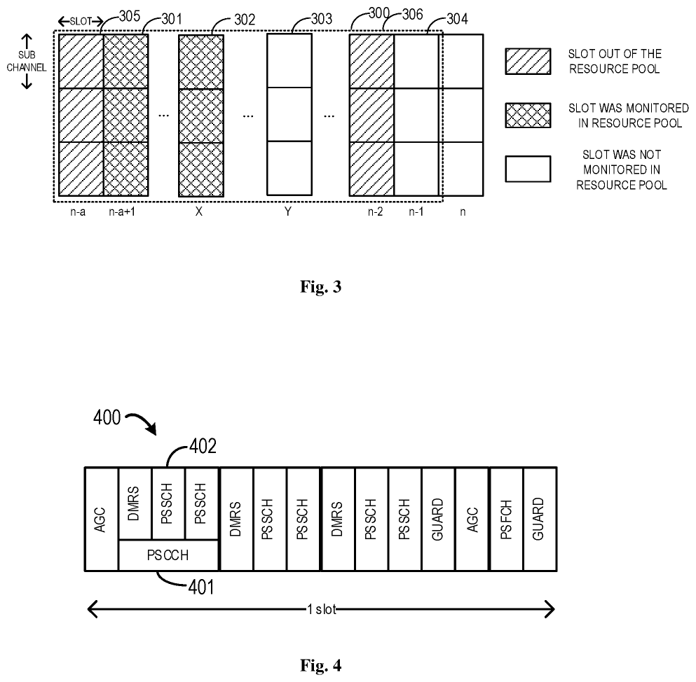

At 210, the first terminal device 110 determines, from the resource pool 102, first resources in a time window before a first slot n based on a resource selection scheme of the first terminal device 110. In some example embodiments, the time window may be a set of slots for determining a congestion level indicator at the first slot n, which is illustrated in FIG. 3. In a case where the congestion level indicator is the CBR, the measurement of CBR may be performed within the time window.

In the example as shown in FIG. 3, the first terminal device 110 may use either the partial sensing scheme or the random selection scheme in selection of resources for transmissions. The time window 300 starts at slot n−a, and ends at slot n−1. The resources 301 and 302 denoted as grid patterned boxes may correspond to slots n−a+/and X which are the resources in the resource pool 102 selected for performing partial sensing, i.e., monitoring and measure RSRP in resource 301 and 302. The resources 303 and 304 denoted as white boxes may correspond to slots Y and n−1 which are the resources in the resource pool 102 not selected for partial sensing. The resources 305 and 306 denoted as diagonal patterned boxes may correspond to slot n−a and slot n−2 which are the resource out of the resource pool 102. In other words, the resources 305 are not configured for sidelink resource pool of the first terminal device 110.

In some example embodiments, the resource selection scheme of the first terminal device 110 may be the partial sensing scheme. In these embodiments, the first resources may be the resources on which the first terminal device 110 performs partial sensing, for example, the resources 301 and 303 as shown in FIG. 3.

In some example embodiments where the resource selection scheme of the first terminal device 110 is the partial sensing scheme, the first terminal device 110 may determine the first resources based on a threshold number S₀. The number N₁′ of the first resources may be larger than or equal to the threshold number S₀, that is, N₁′≥S₀. The threshold number S₀ may be a parameter configured via a radio resource configuration (RRC) parameter, MAC control element (CE), sidelink control information (SCI), downlink control information (DCI), and any other format of message or information suitable for the implementations of the present disclosure.

In the above embodiments, if the first terminal device 110 determines that a number Nₛ of sensing resources on which the first terminal device 110 performs partial sensing (e.g., the number of the resources 301 and 302) is below the number N₁′, that is, Nₛ<N₁′, the first terminal device 110 may further select second resources different from the first resources 301 and 302 from the resource pool 102, for example, the second resources may be selected from the resources 303 and 304. The number of the second resources N₂′ may be larger than or equal to a difference between the number N₁′ and the number N s of the sensing resources 301 and 302. As such, the number N₁′ of the first resources including the sensing resources 301 and 302 and the second resources 303 and 304 may be represented as N₁′=Nₛ+N₂′.

In the above embodiments, if the first terminal device 110 determines that the number Nₛ of sensing resources 301 and 302 exceeds or is equals to the number N₁′, that is, Nₛ≥N₁′, the first terminal device 110 may select all the first resources from the sensing resources, that is, at least part of the sensing resources 301 and 302 is determined to be the first resources.

In some example embodiments, the resource selection scheme of the first terminal device 110 may be the random selection scheme. In these embodiments, the first terminal device 110 may select a preconfigured number S of resources in the time window 300 from the resource pool 102, or alternatively, a number of resources exceeding the preconfigured number S, and determine the selected resources to be the first resources. The preconfigured number S may be a parameter configured via RRC parameter, MAC CE, SCI, DCI, and any other format of message or information suitable for the implementations of the present disclosure.

At 220, the first terminal device 110 determines a first number N₁ of occupied resources in the first resources. To determine the first number N₁, the first terminal device 110 may obtain signal strength parameters (e.g., RSSI) by measuring signals received on the first resources. The first terminal device 110 may then determine the first number N₁ of the occupied resources from the first resources, and each of the occupied resource may correspond to a signal strength parameter above a threshold strength P₀.

In some example embodiments, the signal strength parameters may be a received signal strength indicator measured on the first resources of one or more of the PSSCH and PSCCH based on a reception capability of the first terminal device 110. FIG. 4 illustrates a schematic diagram of an example frame structure 400 in accordance with some embodiments of the present disclosure.

In the embodiments where the first terminal device 110 uses the partial sensing scheme, if the first terminal device 110 has a reception capability on the PSCCH 401 but no reception capability on the PSSCH 402, or alternatively the first terminal device 110 has reception capabilities on both the PSSCH 401 and PSSCH 402, but does not perform reception of signals on PSSCH 402, the first terminal device 110 may obtain the signal strength parameters by measuring the signals received on the PSCCH 401. In this example, the first terminal device 110 may be also referred to as a type 1 UE.

In the above embodiments, if the first terminal device 110 has reception capability on the PSCCH 401 and PSSCH 402, the first terminal device 110 may obtain the signal strength parameters by measuring the signals received on both the PSCCH 401 and PSSCH 402. In this example, the first terminal device 110 may be also referred to as a type 2 UE.

In the example embodiments, if the first terminal device 110 uses the random selection scheme and is the type 1 UE, the first terminal device 110 may obtain the signal strength parameters by measuring the signals received on the PSCCH 401, which is similar to the type 1 UE using the partial sensing scheme. If the first terminal device 110 uses the random selection scheme and is a type 2 UE, the first terminal device 110 may obtain the signal strength parameters by measuring the signals received on both the PSCCH 401 and PSSCH 402, which is similar to the type 2 UE using the partial sensing scheme.

If the first terminal device 110 uses the random selection scheme and has no reception capability on the PSCCH 401 or PSSCH 402, or alternatively, if the first terminal device 110 does not perform reception of signals on the PSCCH 401 or PSSCH 402, the measurement of the signal strength parameters may be performed on a respective sidelink channel 401 and 402 as type 1 or type 2 UE as indicated by a higher layer parameter via, for example, a RRC signaling, MAC CE, DCI, SCI and so on.

At 230, the first terminal device 110 determines the congestion level indicator of the sidelink channel for the first slot n based at least in part on the first number N₁ and a number N₁′ of the first resources. In some example embodiments, the congestion level indicator may be determined to be a ratio R of the first number N₁ to the number of the first resources N₁′, that is, R=N₁/N₁′.

In some example embodiments, in determining the congestion level indicator at 230, the first terminal device 110 may further take the second resources into consideration. In these embodiments, the congestion level indicator may be determined to be a ratio R′ of a sum number of the first number and a weighted second number α₁N₂ to a total number N₀ of resources in the resource pool 102 in the time window 300, that is, R′=(N₁+α₁N₂)/N₀, where the second number N₂ refers to a number of second resources of the resource pool 102 different from the first resources in the time window 300, and the weight α₁, which takes value from 0 to 1, is associated with a traffic priority of the first terminal device 110 which may be configured form RRC parameter.

In these embodiments, the first terminal device 110 may determine the second number N₂ equal to a difference between the total number N₀ and the number of the first resources N₁′, that is, N₂=N₀−N₁′. The sum number of the first number and the weighed second number may be referred to a third number N₃. In other words, the congestion level indicator may be the ratio R′ of the third number N₃ to the total number N₀.

According to embodiment of the present disclosure, there is provided a mechanism for determining control level indicators. By taking the resource allocation mode, resource selection schemes, reception capabilities and reception mode of the terminal devices in to consideration, a balance between power consumptions and accuracies for measuring CBR and evaluation of CR can be achieved.

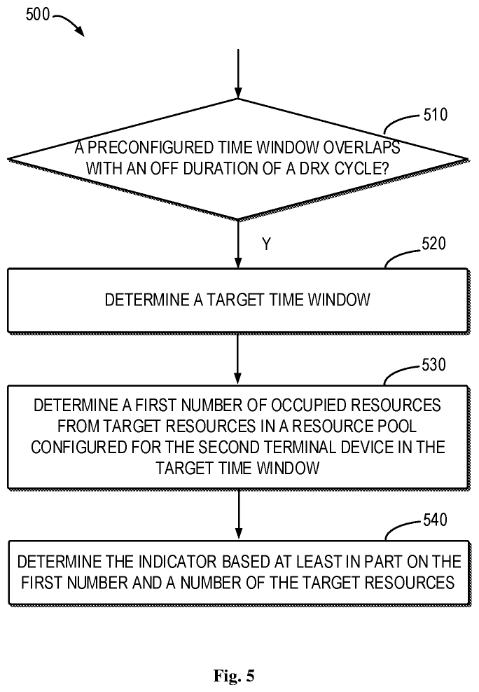

FIG. 5 illustrates a flowchart of an example method in accordance with some embodiments of the present disclosure. In some embodiments, the method 500 can be implemented at a terminal device that may operate in DRX mode, such as the second terminal device 120 as shown in FIG. 1. Additionally, or alternatively, the method 500 can also be implemented at other terminal devices not shown in FIG. 1. For the purpose of discussion, the method 500 will be described with reference to FIG. 1 as performed by the second terminal device 120 without loss of generality.

At 510, the second terminal device 120 determines whether a preconfigured time window overlaps with an off duration of the DRX cycle of the second terminal device 120. The preconfigured time window may be configured via a higher layer of the second terminal device 120. The second terminal device 120 may not monitor the sidelink channel in the off duration, and thus no signal will be received. In other words, the off duration may not be used for determining the congestion level indicator, and a target time window for determining the congestion level indicator at the first slot may be expected.

In the case where the preconfigured time window overlaps with an off duration of the DRX cycle at 510, the second terminal device 120 determines, at 520, a target time window. In the context of the present disclosure, both of the target time window and the preconfigured time window are associated with a congestion level indicator of the sidelink channel in a first slot. The sidelink channel may be associated with the second terminal device 120, for example, the sidelink channel between the first and second terminal devices 110 and 120.

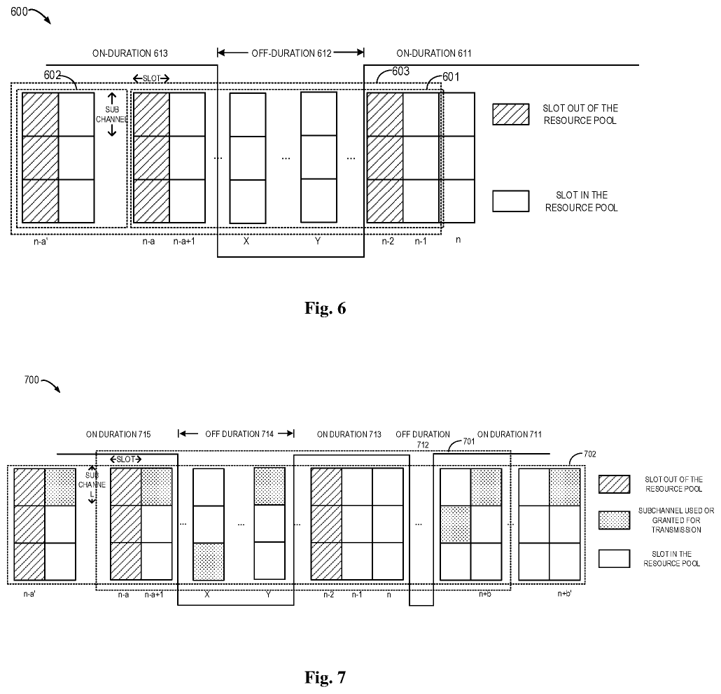

In some example embodiments, the congestion level indicator may be the CBR. FIG. 6 illustrates a schematic diagram of an example scheme 600 for determining the CBR in accordance with some embodiments of the present disclosure. As shown in FIG. 6, the preconfigured time window 601 starts at slot n−a and ends at slot n−1, with the slots n−2 and n−1 in the on duration 611 of the DRX cycle of the second terminal device 120, the slots X and Y in the off duration 612 as well as the slots n−a and n−a+1 in the on duration 613. In this case, the preconfigured time window 601 overlaps with the off duration 612.

The second terminal device 120 may determine, at 520, a rest of the preconfigured time window 601 excluding the off duration 612. The target time window may be determined based on the rest of the preconfigured time window 601. In some example embodiments, the rest of the preconfigured time window 601 may be determined as the target time window.

In some other example embodiments, in addition to the rest of the preconfigured time window 601, the target time window may include extra slots in the resource pool 102. The second terminal device 120 may determine the extra slots based on a higher layer parameter sl-TimeWindowSizeCBR that indicates a size of target resources in a time window for measuring CBR, such as, 100 or 100·2^{μ} slots. If a number of resources of the resource pool 102 in rest of the preconfigured time window 601 is below the threshold size, the second terminal device 120 may determine the target time window by further including extra slots. For example, the second terminal device 120 may determine the slot n−a′ to be the start slot of the target time window, such that a number N₁′ of target resources is equal to a predetermined number S₁, such as, 1000 or 1000·2^{μ} slots. In this example, the end slot of the target time window remains unchanged, that is, the slot n−1.

At 530, the second terminal device 120 determines a first number N₁ of occupied resources from target resources in a resource pool 102 configured for the second terminal device 120 in the target time window. In some example embodiments, the second terminal device 120 may obtain signal strength parameters by measuring signals received on the target resources, and determine the first number N₁ of the occupied resources from the target resources. In these embodiments, each occupied resource may correspond to signal strength parameter above a threshold strength preconfigured via a higher layer.

In the above embodiments, the signal strength parameters may be obtained by measuring in symbols and physical resource blocks configured for one or more of the PSCCH or the PSSCH based on the reception capability of the second terminal device 120. For example, if the second terminal device 120 has a reception capability on the PSCCH but no reception capability on the PSSCH, or alternatively the second terminal device 120 has reception capabilities on both the PSSCH and PSSCH, but does not perform reception of signals on PSSCH, the second terminal device 120 may obtain the signal strength parameters by measuring the signals received on the PSCCH. For another example, if the second terminal device 120 has reception capability on the PSSCH and the PSCCH, the second terminal device 120 may obtain the signal strength parameters by measuring the signals received on both the PSSCH and the PSCCH.

In the example embodiments where the second terminal device 120 has no reception capability on the PSSCH or PSCCH or if the second terminal device 120 does not perform reception of signals on the PSSCH or PSCCH, the measurement of the signal strength parameters may be performed on a respective sidelink channel as indicated by a higher layer parameter via, for example, a RRC signaling, MAC CE, DCI, SCI and so on.

At 540, the second terminal device 120 determines the congestion level indicator of the sidelink channel based at least in part on the first number N₁ and the number of the target resources N₁′. In some example embodiments, the second terminal device 120 may determining a ratio R of the first number N₁ to the number of the target resources N₁′, that is, R=N₁N₁′.

In some other example embodiments, in determining the congestion level indicator at 540, the second terminal device 120 may further take second resources of the resource pool 102 in the off duration into consideration. In this case, the second terminal device 120 may determine a second number N₂ of the second resources, which may be 6 in the example as shown in FIG. 6. The second terminal device 120 may determine a total number N₀ of resources of the resource pool 102 in the target time window including the second resources, which may be 15 in the example as shown in FIG. 6. The second terminal device 120 may then determine a sum of the first number N₁ and a weighted second number α₁N₂ as a third number N₃. The weighted second number α₁N₂ may be determined based on the second number N₂ and a weight α₁ which takes value from 0 to 1 associated with a traffic priority of the second terminal device 120 which may be configured from RRC parameter. In this case, the congestion level indicator may be determined to be a ratio of the third number N₃ to the total number No.

In some other example embodiments, if the second terminal device 120 determines, at 510, the preconfigured time window overlaps with at least one off duration of the DRX cycle, the second terminal device 120 may report the last measured CBR as the CBR at the first slot n.

As another example of the congestion level indicator, the CR at the first slot may be determined by implementing the method 500. The CR at the first slot may be evaluated as a ratio of a number of sub-channels used or granted for transmissions of the second terminal device 120 in a certain time window to a total number of configured sub-channels in the resource pool 102 within the time window.

FIG. 7 illustrates a schematic diagram of an example scheme 700 for determining the CR in accordance with some embodiments of the present disclosure. As shown in FIG. 7, a preconfigured time window 701 for determining the CR at the first slot n starts at slot n−a and ends at slot n+b. The resources denoted as grid patterned boxes may correspond to slots n−a′, n−a and n−2 which are the resources out of the resource pool 102. The resources denoted as dotted boxes may correspond to the resources used or granted for transmissions of the second terminal device 120. The resources denoted as white boxes may correspond to the resource of the resource pool 102 but not used or granted for the second terminal device 120.

Likewise, at 510, the second terminal device 120 may determine whether that preconfigured time window 701 overlaps with at least one off duration of the DRX cycle of the second terminal device 120. In the example shown in FIG. 7, the second terminal device 120 determines that preconfigured time window 701 overlap with the off durations 712 and 714.

In these cases, since the second terminal device 120 does not perform either transmission or reception during the off durations, the preconfigured time window 701 may not be suitable for determining the CR. At 520, the second terminal device 120 determines a target time window. For example, the target time window may be determined based on a rest of the preconfigured time window 701 excluding the off durations 712 and 714.

In some example embodiments, the second terminal device 120 may determine the rest of the preconfigured time window 701 excluding the off durations 712 and 714 as the target time window. In this case, the target time window may include slots n−a+1, n−1, n, n+b−1, and n+b. In some other example embodiments, the resources in the rest of the preconfigured time window 701 may not be sufficient for determining the CR. In this case, in addition to the rest of the preconfigured time window 701, the target time window may include extra slots in the resource pool 102.

In the above case, the second terminal device 120 may determine the extra slots based on the higher layer parameter sl-TimeWindowSizeCR that indicates a size of target resources in a time window for evaluation of CR, such as, 1000 or 1000·2^{μ} slots. If a number of resources of the resource pool 102 in rest of the preconfigured time window 701 is below the predetermined number S₁, for example, 1000 or 1000·2^{μ} slots, the second terminal device 120 may determine the target time window by further including extra slots. For example, the second terminal device 120 may determine the slot n−a′ to be the start slot of the target time window, and the slot n+b′ to be the end slot, where b′<(a′+b′+1)/2, such that a number N₁′ of target resources is equal to the predetermined number S₁. In this example, the end slot of the target time window should occur before a last transmission opportunity granted for a current transmission of the second terminal device 120 in time domain.

At 530, the second terminal device 120 may determine a first number N₁ of occupied resources from target resources in the resource pool 102 in the target time window 701. In the embodiments where the start slot of the target time window is slot n−a, the second terminal device 120 may determine the first number N₁ of sub-channels used for its transmissions in slots [n−a, n−1] and sub-channels granted in slots [n, n+b]. In the embodiments where the start slot of the target time window is slot n−a′, the second terminal device 120 may determine the first number N₁ of sub-channels used for its transmissions in slots [n−a′, n−1] and sub-channels granted in slots [n, n+b′].

At 540, the second terminal device 120 may determine the CR based at least in part on the first number N₁ and a number N₁′ of the target resources. In some example embodiments, the second terminal device 120 may determining a ratio R of the first number N₁ to the number of the target resources N₁′, that is, R=N₁/N₁′.

In some other example embodiments, in determining CR at 540, the second terminal device 120 may further take second resources of the resource pool 102 in the off duration into consideration. In this case, the second terminal device 120 may determine a second number N₂ of the second resources, for example, slots in off durations 712 and 714 as shown in FIG. 7. The second terminal device 120 may determine a total number N₀ of resources of the resource pool 102 in the target time window including the second resources. The second terminal device 120 may then determine a sum of the first number N₁ and a weighted second number α₁N₂ as a third number N₃. The weighted second number α₁N₂ may be determined based on the second number N₂ and a weight α₁ which take value from 0 to 1 associated with a traffic priority of the second terminal device 120 which may be configured from RRC parameter. In this case, the CR at the first slot n may be determined to be a ratio of the third number N₃ to the total number N₀.

In some other example embodiments, if the second terminal device 120 determines, at 510, the preconfigured time window overlaps with at least one off duration of the DRX cycle, the second terminal device 120 may report the last evaluated CR as the CR at the first slot n.

According to embodiment of the present disclosure, there is provided a mechanism for determining control level indicators based on the resource allocation mode, resource selection schemes, reception capabilities and reception mode of the terminal devices. As such, a balance between power consumptions and accuracies for measuring CBR and evaluation of CR can be achieved.

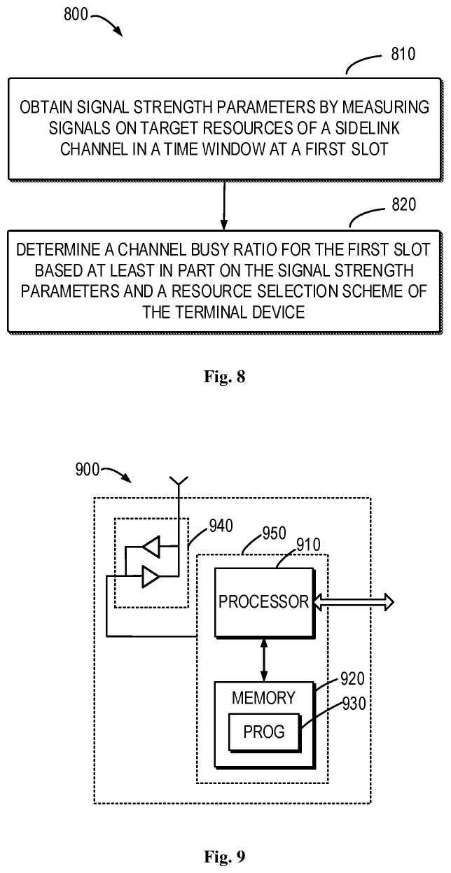

FIG. 8 illustrates a flowchart of an example method 800 in accordance with some embodiments of the present disclosure. In some embodiments, the method 800 can be implemented at a terminal device, such as the first terminal device 110 as shown in FIG. 1. Additionally, or alternatively, the method 800 can also be implemented at other terminal devices not shown in FIG. 1. For the purpose of discussion, the method 800 will be described with reference to FIG. 1 as performed by the first terminal device 110 without loss of generality.

At 810, the first terminal device 110 obtains signal strength parameters by measuring signals on target resources of a sidelink channel in a time window at a first slot. The sidelink channel is associated with the first terminal device 110.

In some example embodiments, the resource selection scheme of the first terminal device 110 may be a partial sensing scheme. In these embodiments, the target resources may include sub-channels corresponding to slots monitored by the first terminal device 110 based on the partial sensing scheme.

In some example embodiments, the resource selection scheme of the first terminal device 110 may be one of a random selection scheme and a partial sensing scheme, and the target resources may include sub-channels corresponding to at least a threshold number of slots selected by the first terminal device 110 from the resource pool 102. In other words, a number of target slots corresponding to the target resources may be larger than or equal to the threshold number S₀. The threshold number S₀ may be a parameter configured via a RRC message, MAC CE, SCI, DCI and so on.

In the above embodiments where the resource selection scheme of the first terminal device 110 is the partial sensing scheme, the first terminal device 110 may determine whether a number of first slots monitored by the terminal device based on the partial sensing scheme exceeds the number of the target slots. In accordance with a determination that the number of first slots exceeds the number of the target slots, the first terminal device 110 may select all the target resources from the first resources, that is, at least a part of the first slots is determined to be the target slots. In accordance with a determination that the number of the first slots is below the number of the target slots, the first terminal device 110 may determine the first resources as a first part of the target resources. The first terminal device 110 may then select, from the resources pool 102, second resources different from the first resources to be a second part of the target resources. The second resources include second sub-channels corresponding to second slots, and as a result, a sum number of the first and second slots may be equal to the number of the target resources.

In some example embodiments, the first terminal device 110, at 810, may determine the first number N₁ of occupied resources from the target resources. To determine the first number N₁, the first terminal device 110 may obtain signal strength parameters (e.g., RSSI) by measuring signals received on the target resources. The first terminal device 110 may then determine the first number N₁ of the occupied resources from the target resources. In these example embodiments, each occupied resource corresponds to a signal strength parameter above a threshold strength P₀.

In some example embodiments, the signal strength parameters may be obtained on the resources of one or more of the PSCCH or PSSCH based on a reception capability of the first terminal device 110.

In some example embodiments, the first terminal device 110 may have a reception capability on the PSCCH but no reception capability on the PSSCH. In this case, the first terminal device 110, at 810, may obtain the signal strength parameters by measuring the signals received on the PSCCH. In this example, the first terminal device 110 may be also referred to as a type 1 UE.

In some example embodiments, the first terminal device 110 may have reception capability on the PSSCH and the PSCCH. In this case, the first terminal device 110, at 810, may obtain the signal strength parameters by measuring the signals received on both the PSSCH and the PSCCH. In this example, the first terminal device 110 may be also referred to as a type 2 UE.

At 820, the first terminal device 110 determines a channel busy ratio for the first slot based at least in part on the signal strength parameters and a resource selection scheme of the first terminal device 110. In some example embodiments, at 820, the first terminal device 110 may determine a ratio of the first number N₁ to a number N₁ ′ of the target resources.

In some example embodiments, the first terminal device 110 may determine a total number N₀ of resources in the resource pool 102 in the time window. The first terminal device 110 may determine a second number N₂ equal to a difference between the total number N₀ and a number of the target resources N₁′. The first terminal device 110 may then determine a sum of the first number N₁ and a weighted second number α₁N₂ as a third number N₃. The weighted second number α₁N₂ may be determined by applying a weight α₁ to the second number N₂, and the weight α₁ takes value from 0 to 1 and is associated with a traffic priority of the first terminal device 110 which may be configured form RRC parameter. The channel busy ratio determined at 820 may be a ratio R of the third number N₃ to the total number N₀.

According to embodiment of the present disclosure, there is provided a mechanism for determining control level indicators based on the resource allocation mode, resource selection schemes, reception capabilities and reception mode of the terminal devices. As such, a balance between power consumptions and accuracies for measuring CBR can be achieved.

FIG. 9 is a simplified block diagram of a device 900 that is suitable for implementing some embodiments of the present disclosure. The device 900 can be considered as a further example embodiment of the terminal devices 110 and 120 as well as the network device 102 as shown in FIG. 1. Accordingly, the device 900 can be implemented at or as at least a part of the terminal devices 110 and 120 as well as the network device 102.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 920 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S₁ interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 930 is assumed to include program instructions that, when executed by the associated processor 910, enable the device 900 to operate in accordance with the embodiments of the present disclosure, as discussed herein with reference to any of FIGS. 2, 5 and 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general-purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a first terminal device comprises circuitry configured to: determine, from a resource pool configured for the first terminal device, first resources in a time window before a first slot based on a resource selection scheme of the first terminal device; determine a first number of occupied resources in the first resources; and determine a congestion level indicator of a sidelink channel for the first slot based at least in part on the first number and a number of the first resources, the sidelink channel associated with the first terminal device.

In some embodiments, the resource selection scheme of the first terminal device comprises a partial sensing scheme and the circuitry is configured to determine the first resources by: determining resources on which the first terminal device performs partial sensing to be the first resource.

In some embodiments, the resource selection scheme of the first terminal device comprises one of a partial sensing scheme and a random selection scheme, and the circuitry is configured to determine the first resources by: selecting, from the resource pool, a preconfigured number of resources in the time window; and determining the preconfigured number of resources to be the first resources.

In some embodiments, the resource selection scheme of the first terminal device comprises the partial sensing scheme and the circuitry is configured to determine the set of first resources by: in accordance with a determination that a number of sensing resources on which the first terminal device performs partial sensing is below a threshold number, selecting, from the resource pool, second resources different from the first resources, a sum number of the sensing resources and the second resources exceeding the threshold number; and determining the first resources comprising the sensing resources and the second resources; and in accordance with a determination that the number of the sensing resources is above the threshold number, determining at least a part of the sensing resources as the first resources.

In some embodiments, the circuitry is configured to determine the first number of occupied resources by: obtaining signal strength parameters by measuring signals received on the first resources; and determining the first number of the occupied resources from the first resources, each occupied resource corresponding to a signal strength parameter above a threshold strength.

In some embodiments, the signal strength parameters are obtained on the first resources of one or more of a physical sidelink control channel or a physical sidelink shared channel based on a reception capability of the first terminal device.

In some embodiments, the circuitry is configured to obtain the signal strength parameters by: in accordance with a determination that the first terminal device has a reception capability on the physical sidelink control channel but no reception capability on the physical sidelink shared channel, obtaining the signal strength parameters by measuring the signals received on the physical sidelink control channel.

In some embodiments, the circuitry is configured to obtain the signal strength parameters by: in accordance with a determination that the first terminal device has reception capability on the physical sidelink shared channel and the physical sidelink control channel, obtaining the signal strength parameters by measuring the signals received on both the physical sidelink shared channel and the physical sidelink control channel.

In some embodiments, the circuitry is configured to determine the congestion level indicator by: determining a ratio of the first number to the number of the first resources.

In some embodiments, the circuitry is configured to determine the congestion level indicator by: determining a total number of resources in the resource pool in the time window; determining a second number equal to a difference between the total number and the number of the first resources; determining, as a third number, a sum of the first number and a weighted second number, the weighted second number determined by applying, to the second number, a weight associated with a traffic priority of the first terminal device; and determining a ratio of the third number to the total number.

In some embodiments, the congestion level indicator comprises a sidelink channel busy ratio.

In some embodiments, a second terminal device comprises circuitry configured to: in accordance with a determination that a preconfigured time window overlaps with an off duration of a discontinuous receipt cycle of a second terminal device, determine a target time window at the second terminal device, both the target time window and the preconfigured time window associated with a congestion level indicator of a sidelink channel of the second terminal device in a first slot; determine a first number of occupied resources from target resources in a resource pool configured for the second terminal device in the target time window; and determine the congestion level indicator of a sidelink channel based at least in part on the first number and a number of the target resources, the sidelink channel associated with the second terminal device.

In some embodiments, the second terminal device comprises circuitry configured to determine the target time window by: determining a rest of the preconfigured time window excluding the off duration as the target time window; and determining the target time window based on the rest of the preconfigured time window.

In some embodiments, the congestion level indicator comprises a sidelink channel busy ratio, an end slot of the preconfigured time window is the first slot, and the circuitry is configured to determine the target time window by: determining a start slot of the target time window such that the number of target resources exceeds a threshold number, an end slot of the target time window being the first slot.

In some embodiments, the congestion level indicator comprises a sidelink channel occupancy ratio, and the circuitry is configured to determine the target time window by: determining a start slot and an end slot such that the number of target resources exceeds a threshold number, the end slot being before a last transmission opportunity granted to the second terminal device in time domain.

In some embodiments, the congestion level indicator comprises a sidelink channel busy ratio, and the circuitry is configured to determine the first number of occupied resources by: obtaining signal strength parameters by measuring signals received on the target resources; and determining the first number of the occupied resources from the target resources, each occupied resource corresponding to signal strength parameter above a threshold strength.

In some embodiments, the signal strength parameters are obtained on the target resources of one or more of a physical sidelink control channel or a physical sidelink shared channel based on a reception capability of the second terminal device.

In some embodiments, the circuitry is configured to obtain the signal strength parameters by: in accordance with a determination that the second terminal device has a reception capability on the physical sidelink control channel but no reception capability on the physical sidelink shared channel, obtaining the signal strength parameters by measuring the signals received on the physical sidelink control channel.

In some embodiments, the circuitry is configured to obtain the signal strength parameters by: in accordance with a determination that the second terminal device has reception capability on the physical sidelink shared channel and the physical sidelink control channel, obtaining the signal strength parameters by measuring the signals received on both the physical sidelink shared channel and the physical sidelink control channel.

In some embodiments, the circuitry is configured to determine the congestion level indicator by: determining a ratio of the first number to the number of the target resources.

In some embodiments, the circuitry is configured to determine the congestion level indicator by: determining a second number of second resources of the resource pool in the off duration; determining a total number of resources of the resource pool in the target time window including the second resources; determining, as a third number, a sum of the first number and a weighted second number, the weighted second number determined based on the second number and a weight associated with a traffic priority of the second terminal device; and determining a ratio of the third number to the total number.

In some embodiments, the congestion level indicator comprises one of a sidelink channel busy ratio or sidelink channel occupancy ratio.

In some embodiments, a terminal device comprises circuitry configured to: obtain signal strength parameters by measuring signals on target resources of a sidelink channel in a time window at a first slot, the sidelink channel associated with the terminal device; and determine a channel busy ratio for the first slot based at least in part on the signal strength parameters and a resource selection scheme of the terminal device.

In some embodiments, the resource selection scheme of the terminal device comprises a partial sensing scheme, and the target resources comprise sub-channels corresponding to slots monitored by the terminal device based on the partial sensing scheme.

In some embodiments, the resource selection scheme of the terminal device comprises one of a random selection scheme and a partial sensing scheme, and the target resources comprise sub-channels corresponding to at least a threshold number of slots selected by the terminal device from the resource pool, the threshold number is a preconfigured parameter.

In some embodiments, the resource selection scheme of the terminal device comprises the partial sensing scheme, and the circuitry is configured to: in accordance with a determination that a number of first slots monitored by the terminal device based on the partial sensing scheme exceeds the threshold number, select first resources comprising first sub-channels corresponding to at least a part of the first slots as the resources; and in accordance with a determination that the number of the first slots is below the threshold number, determine the first resources as a first part of the target resources; and select, from the resources pool, second resources different from the first resources to be a second part of the target resources, the second resources comprising second sub-channels corresponding to second slots, a sum number of the first and second slots exceeding the threshold number.

In some embodiments, the circuitry is configured to obtain signal strength parameters further by: determining a first number of occupied resources from the target resources, each occupied resource corresponding to a signal strength parameter above a threshold strength.

In some embodiments, the circuitry is configured to determine the channel busy ratio by: determining a ratio of the first number to a number of the target resources.

In some embodiments, the circuitry is configured to determine the channel busy ratio by: determining a total number of resources in the resource pool in the time window; determining a second number equal to a difference between the total number and a number of the target resources; determining, as a third number, a sum of the first number and a weighted second number, the weighted second number determined by applying, to the second number, a weight associated with a traffic priority of the terminal device; and determining a ratio of the third number to the total number.

In some embodiments, the signal strength parameters are obtained on the resources of one or more of a physical sidelink control channel or a physical sidelink shared channel based on a reception capability of the terminal device.

In some embodiments, the circuitry is configured to obtain the signal strength parameters by: in accordance with a determination that the terminal device has a reception capability on the physical sidelink control channel but no reception capability on the physical sidelink shared channel, obtaining the signal strength parameters by measuring the signals received on the physical sidelink control channel.

In some embodiments, the circuitry is configured to obtain the signal strength parameters by: in accordance with a determination that the terminal device has reception capability on the physical sidelink shared channel and the physical sidelink control channel, obtaining the signal strength parameters by measuring the signals received on both the physical sidelink shared channel and the physical sidelink control channel.

The components included in the apparatuses and/or devices of the present disclosure may be implemented in various manners, including software, hardware, firmware, or any combination thereof. In some embodiments, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2, 7 and 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general-purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine-readable medium, which may be any tangible medium that may contain, or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-38. (canceled)

39. A method comprising:
performing a SL RSSI (SideLink Received Signal Strength Indicator) measurement in slots where a terminal performs partial sensing within a CBR (Channel Busy Ratio) measurement window; and
measuring SL CBR (SideLink Channel Busy Ratio) based on the SL RSSI measurement.

40. The method according to claim 39, wherein
the number of the slots is larger than or equal to a configured threshold.

41. A terminal comprising a processor configured to:
perform a SL RSSI (SideLink Received Signal Strength Indicator) measurement in slots where the terminal performs partial sensing within a CBR (Channel Busy Ratio) measurement window; and
measure SL CBR (SideLink Channel Busy Ratio) based on the SL RSSI measurement.

42. The terminal according to claim 41, wherein
the number of the slots is larger than or equal to a configured threshold.
